(19) United States
(12) Patent Application Publication
(10) Pub. No.: US 2025/0370266 A1
(43) Pub. Date: Dec. 4, 2025

(54) HEAD-MOUNTED DISPLAY DEVICE AND OPERATION METHOD OF THE SAME

(71) Applicant: SAMSUNG ELECTRONICS CO., LTD., Suwon-si (KR)

(72) Inventors: Woojae KIM, Suwon-si (KR); Byeongwook YOO, Suwon-si (KR); Junho KWAK, Suwon-si (KR); Gunill LEE, Suwon-si (KR); Wonwoo LEE, Suwon-si (KR); Jiwon JEONG, Suwon-si (KR)

(73) Assignee: SAMSUNG ELECTRONICS CO., LTD., Suwon-si (KR)

(21) Appl. No.: 19/223,949

(22) Filed: May 30, 2025

Related U.S. Application Data
(63) Continuation of application No. PCT/KR2025/007181, filed on May 27, 2025.

(30) Foreign Application Priority Data
May 31, 2024 (KR) 10-2024-0071807

(51) Int. Cl. G02B 27/01; G02B 27/00; G06V 20/20; G06V 40/10

(52) U.S. Cl. CPC G02B 27/0172; G02B 27/0093; G06V 20/20; G06V 40/103; G02B 2027/0138; G02B 2027/014; G02B 2027/0178

(57) ABSTRACT

Provided are a head-mounted display (HMD) device and an operation method of the head-mounted display (HMD) device. The method may include obtaining an original image by capturing a real environment, detecting at least one object included in the original image, obtaining depth information of the detected at least one object using the original image, identifying a target object from among the detected at least one object, based on depth information, inpainting a region corresponding to the identified target object in the original image and displaying the inpainted image.

### CROSS-REFERENCE TO RELATED APPLICATIONS

This application is a bypass continuation application of International Application No. PCT/KR2025/007181, filed on May 27, 2025, which claims priority to Korean Patent Application No. 10-2024-0071807, filed on May 31, 2024, in the Korean Intellectual Property Office, the disclosures of which are incorporated by reference herein in their entireties.

### BACKGROUND

### 1. Field

Provided are a head-mounted display device and an operation method of the same. More particularly, provided are a head-mounted display device and an operation method of the same, wherein the head-mounted display device performs inpainting, based on a distance between the head-mounted display device and an object in an image captured of a real environment.

### 2. Description of Related Art

Video see-through (VST) of a head-mounted display (HMD) device is a function that allows a user to observe a real environment through an image in a virtual reality (VR) or augmented reality (AR) environment.

The HMD device may provide the user with a new experience and a sense of immersion by inpainting an object that exists in the real environment displayed through the VST.

### SUMMARY

According to an aspect of the disclosure, an operation method of a head-mounted display (HMD) device may be provided. In an embodiment of the disclosure, the operation method may include obtaining an original image by capturing a real environment. In an embodiment of the disclosure, the operation method may include detecting at least one object included in the original image. In an embodiment of the disclosure, the operation method may include obtaining depth information of the at least one detected object using the original image. In an embodiment of the disclosure, the operation method may include identifying a target object among the detected at least one object based on the depth information. In an embodiment of the disclosure, the operation method may include inpainting a region corresponding to the identified target object in the original image. In one embodiment, the operation method may include displaying the inpainted image.

According to an aspect of the disclosure, an HMD device is disclosed. The HMD device may include a display, a stereo camera, a memory storing at least one instruction and at least one processor configured to execute the at least one instruction stored in the memory. In an embodiment of the disclosure, the at least one instruction, when executed by the at least one processor, causes the HMD device to obtain an original image by capturing a real environment through the stereo camera. In an embodiment of the disclosure, the at least one instruction, when executed by the at least one processor, causes the HMD device to obtain depth information of the at least one detected object using the original image. In an embodiment of the disclosure, the at least one instruction, when executed by the at least one processor, causes the HMD device to identify a target object among the detected at least one object based on the depth information. In an embodiment of the disclosure, the at least one instruction, when executed by the at least one processor, causes the HMD device to inpaint a region corresponding to the identified target object in the original image. In one embodiment, the at least one instruction, when executed by the at least one processor, further causes the HMD device to display the inpainted image through the display.

According to an aspect of the disclosure, a computer-readable recording medium having recorded thereon a program for executing any one of the aforementioned and following methods of performing operations of the HMD device may be provided.

### BRIEF DESCRIPTION OF THE DRAWINGS

The above and other aspects and/or features of embodiments of the disclosure will be more apparent from the following description taken in conjunction with the accompanying drawings, in which:

FIG. 1 is a diagram for schematically describing operation of a head-mounted display (HMD) device according to an embodiment of the disclosure.

FIG. 2 is a flowchart for describing operation of an HMD device according to an embodiment of the disclosure.

FIG. 3 is a diagram for describing operations of an HMD device for detecting an object and identifying a distance from the HMD device to the object, according to an embodiment of the disclosure.

FIGS. 4A, 4B and 4C are diagrams for describing an operation of an HMD device for determining an inpainting target, according to an embodiment of the disclosure.

FIG. 5 is a diagram for describing a mask map according to an embodiment of the disclosure.

FIGS. 6A and 6B are diagrams for describing a preset distance determined based on a virtual object, according to an embodiment of the disclosure.

FIG. 7 is a diagram for describing a first field of view (FOV) of an original image and a second FOV of an outer view image, according to an embodiment of the disclosure.

FIGS. 8A, 8B and 8C are diagrams for describing user interfaces according to an embodiment of the disclosure.

FIG. 9 is a flowchart for describing an operation of an HMD device for performing inpainting based on whether the inpainting is required, according to an embodiment of the disclosure.

FIG. 10 is a flowchart for describing an operation of an HMD device for performing noise canceling, according to an embodiment of the disclosure.

FIG. 11 is a perspective view of an HMD device according to an embodiment of the disclosure.

FIG. 12 is a detailed block diagram of an HMD device according to an embodiment of the disclosure.

FIG. 13 is a detailed block diagram of a server according to an embodiment of the disclosure.

### DETAILED DESCRIPTION

The terms are selected from among common terms widely used at present, taking into account principles of the disclosure, which may however depend on intentions of those of ordinary skill in the art, judicial precedents, emergence of new technologies, and the like. Some terms as herein used are selected at the applicant's discretion, in which case, the terms will be explained later in detail in connection with embodiments of the disclosure. Therefore, the terms should be defined based on their meanings and descriptions throughout the disclosure.

Unless the context clearly indicates otherwise, the singular forms “a”, “an”, and “the” are to be understood to include plural objects. Hence, for example, “a configuration surface” may include referring to one or more of such surfaces.

All terms including technical and scientific terms used herein have the same meaning as commonly understood by one of ordinary skill in the art to which this disclosure belongs.

The term “include (or including)” or “comprise (or comprising)” is inclusive or open-ended and does not exclude additional, unrecited elements or method steps. The terms “unit”, “module”, “block”, etc., as used herein each represent a unit for handling at least one function or operation, and may be implemented in hardware, software, or a combination thereof.

The expression “configured to” as herein used may be interchangeably used with “suitable for”, “having the capacity to”, “designed to”, “adapted to”, “made to”, or “capable of” according to the given situation. The expression “configured to” may not necessarily mean “specifically designed to” in terms of hardware. For example, in some situations, an expression “a system configured to do something” may refer to “an entity able to do something in cooperation with” another device or parts. For example, “a processor configured to perform A, B and C functions” may refer to a dedicated processor, e.g., an embedded processor for performing A, B and C functions, or a general purpose processor, e.g., a Central Processing Unit (CPU) or an application processor that may perform A, B and C functions by executing one or more software programs stored in a memory.

It is to be understood that blocks of each flowchart and combinations of flowcharts may be performed by one or more computer programs including computer-executable instructions. The one or more computer programs may be stored all in a single memory or may be distributed in many different memories.

All functions or operations as described in the disclosure may be processed by a single processor or a combination of processors. The single processor or the combination of processors are circuitries for performing processing, which may include an application processor (AP), a communication processor (CP), a graphical processing unit (GPU), a neural processing unit (NPU), a microprocessor unit (MPU), a system on chip (SoC), an integrated chip (IC), etc.

In the disclosure, augmented reality (AR) refers to showing a virtual image with a real environment (or real world) that is a physically existing space in the real world or showing a real object that exists in the real environment with the virtual image.

In the disclosure, virtual reality (VR) refers to showing an image of a virtual environment (or virtual world) created by a computer graphics technology, which is a separate space from the real environment.

In the disclosure, mixed reality (MR) refers to providing an experience to come and go between imagination and reality through interactions between an object that exists in the real environment and an object in the virtual environment.

In the disclosure, a head-mounted display (HMD) device may refer to an AR device capable of representing AR, a VR device capable of representing VR or and MR device capable of representing MR. In an embodiment of the disclosure, the HMD device may have the form of glasses worn on the face of the user or a helmet worn on the head of the user, but is not limited thereto.

In the disclosure, inpainting may refer to changing or reconstructing pixels in a preset area designated as an inpainting target included in an image into pixels with visual features naturally connected to surrounding areas by applying an inpainting algorithm according to an embodiment as will be described later.

In the disclosure, an artificial intelligence (AI) model may refer to a set of functions or algorithms configured to perform desired characteristics (or purposes) by being trained with a lot of learning data according to a learning algorithm. Examples of the learning algorithm may include supervised learning, unsupervised learning, semi-supervised learning, or reinforcement learning, without being limited thereto. In an embodiment of the disclosure, the AI model may be stored in a memory of the HMD device. It is not, however, limited thereto, and the AI model may be stored in an external server, and the HMD device may transmit data to be input to the AI model and receive data output from the AI model from the server.

In the disclosure, the AI model may be made up of a plurality of neural network layers. Each of the plurality of neural network layers may have a plurality of weight values, and perform neural network operation through operation between an operation result of the previous layer and the plurality of weight values. The plurality of weight values owned by the plurality of neural network layers may be optimized by learning results of the AI model. For example, the plurality of weight values may be updated to reduce or minimize a loss value or a cost value obtained by the AI model during a training procedure. The model including the plurality of neural network layers may include, for example, a convolutional neural network (CNN), a DNN, a recurrent neural network (RNN), a restricted Boltzmann machine (RBM), a deep belief network (DBN), a bidirectional recurrent deep neural network (BRDNN), a deep Q-network, etc., without being limited thereto.

In the disclosure, data processing related to an image may refer to data processing on each of a plurality of frames that make up the image.

An embodiment of the disclosure will now be described in detail with reference to accompanying drawings to be readily practiced by those of ordinary skill in the art. However, the disclosure may be implemented in many different forms, and not limited to an embodiment as will be discussed herein. In the drawings, parts unrelated to the description are omitted for clarity, and like numerals refer to like elements throughout the disclosure.

The disclosure will now be described with reference to accompanying drawings.

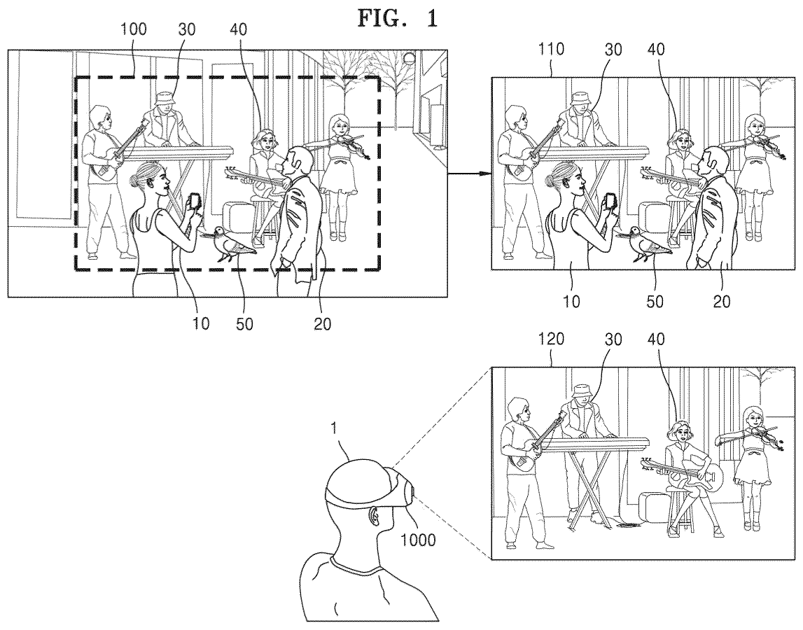

FIG. 1 is a diagram for schematically describing an operation of an HMD device, according to an embodiment of the disclosure.

Referring to FIG. 1, an HMD device 1000 may obtain an original image 110 by capturing an image of a real environment. The real environment may refer to a physical space of the real world where a user 1 exists, and may include various objects. For example, in the real environment, there may be inanimate objects such as a building, a road, etc., and biological objects such as humans, animals, etc.

In an embodiment of the disclosure, the original image 110 may be an image obtained by performing capturing with a preset field of view (FOV) 100. In an embodiment of the disclosure, the original image 110 may include an object that may be observed with the preset FOV 100 in the real environment. For example, the original image 110 may include, but not exclusively, a first person 10, a second person 20, a third person 30, a fourth person 40 and a pigeon 50, which are observed with the preset FOV 100 in the real environment.

In an embodiment of the disclosure, the HMD device 1000 may include various types of devices for displaying the original image 110. For example, the HMD device 1000 may include, but not exclusively, an MR device that displays, through a display, an image obtained in real time by a camera, or a VR device that displays a prestored image through the display.

In an embodiment of the disclosure, the HMD device 1000 may detect at least one object included in the original image 110. In an embodiment of the disclosure, the HMD device 1000 may obtain depth information of the detected at least one object using the original image. In an embodiment of the disclosure, the HMD device 1000 may determine (e.g., identify) a target object among the detected at least one object based on depth information. The target object may include an object to be subject to inpainting, which will be described later, among the detected at least one object. In an embodiment of the disclosure, the HMD device 1000 may identify at least one object located in a preset distance range from the HMD device 1000 among the detected at least one object based on the depth information, and determine the target object from among the identified at least one object.

For example, the user 1 may want to watch the third person 30 and the fourth person 40 who are performing busking in a real environment through the HMD device 1000. In this case, as the first person 10, the second person 20 and the pigeon 50 block the third person 30 and the fourth person 40, they are tantamount to elements interfering with the watching from a perspective of the user 1. Hence, the HMD device 1000 may detect the first person 10, the second person 20, the third person 30, the fourth person 40 and the pigeon 50 included in the original image 110, and determine the first person 10, the second person 20 and the pigeon 50 located between the HMD display 1000, the third person 30 and the fourth person 40 as target objects based on depth information of the detected objects.

In an embodiment of the disclosure, the HMD device 1000 may inpaint a region corresponding to the target objects in the original image 110. In an embodiment of the disclosure, the HMD device 1000 may display inpainted image 120.

For example, the HMD device 1000 may obtain the inpainted image 120 where the pixels representing areas of the first person 10, the second person 20 and the pigeon 50 are reconstructed (or restored) into pixels that represent areas of the real environment blocked by the first person 10, the second person 20 and the pigeon 60 by inpainting a region corresponding to the first person 10, the second person 20 and the pigeon 50 included in the original image 110. The inpainted area 120 may further include portions of the third person 30 and fourth person 40 blocked by the first person 10, the second person 20 and the pigeon 50 in the original image 110. Accordingly, the user 1 may indulge in enjoying the busking performance of the third person 30 and the fourth person 40 through the inpainted image 120.

As such, according to an embodiment of the disclosure, by determining a target object based on depth information of at least one object included in the original image 110, inpainting may be performed by taking into account a physical distance between the HMD device 1000 and the object in the real environment. In that inpainting is performed by taking into account spatial information of the real environment where the user 1 exists, the user 1 may have an immersive experience of the real environment separated from unnecessary elements.

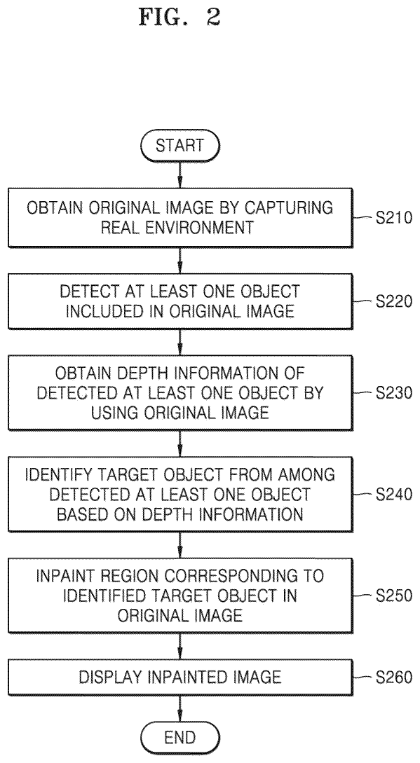

FIG. 2 is a flowchart for describing operation of an HMD device, according to an embodiment of the disclosure.

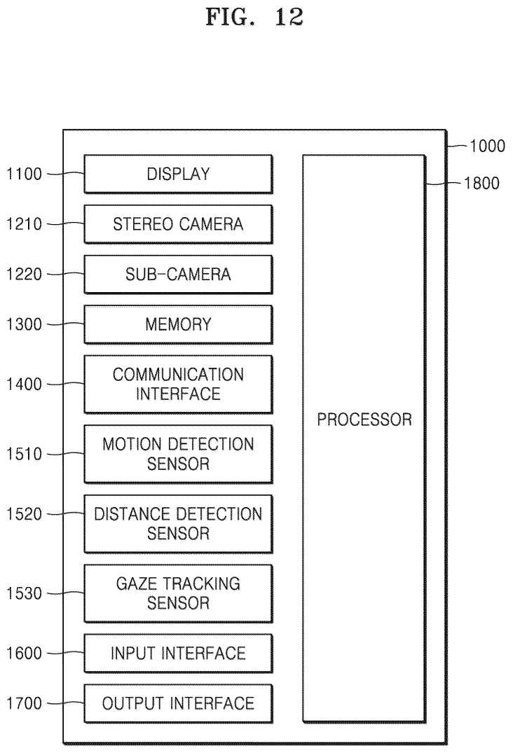

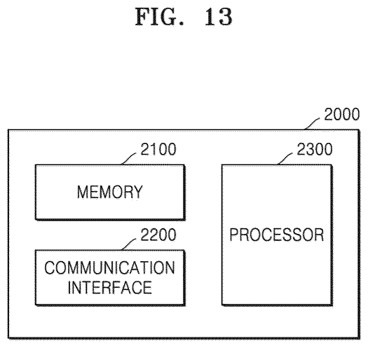

Referring to FIG. 2, operations of the HMD device 1000 will be schematically described, and the detailed description of each operation will be described with reference to subsequent drawings. The operations of the HMD device 1000 described in the disclosure may be understood as operations of a processor 1800 of the HMD device 1000 as shown in FIG. 12 and a processor 2300 of a server 2000 as shown in FIG. 13.

In operation S210, the HMD device 1000 may obtain an original image by capturing a real environment.

In an embodiment of the disclosure, the HMD device 1000 may obtain the original image based on an image (e.g., stereo image) obtained through a stereo camera included in the HMD device 1000 or a prestored panorama image.

In an embodiment of the disclosure, the HMD device 1000 may include the stereo camera. In an embodiment of the disclosure, the stereo camera may include a left camera and a right camera. The left camera and the right camera are located at certain distances from the HMD device 1000, and may obtain left and right images by capturing an image of the real environment, where the user who wears the HMD device 1000 is located, at different angles. In an embodiment of the disclosure, the HMD device may obtain the left and right images obtained through the left and right cameras as original images. In an embodiment of the disclosure, the obtained left and right images may be displayed on a display (or a first region on a display) of the HMD device corresponding to the left eye of the user and a display (or a second region on the display) of the HMD device corresponding to the right eye of the user, respectively.

In an embodiment of the disclosure, the HMD device 1000 may obtain a prestored panorama image. The prestored panorama image may include an image stored in advance by capturing an image of the real environment before the use of the HMD device 1000. In an embodiment of the disclosure, the prestored panorama image may include an image captured with an FOV wider than an FOV of an image displayed through the HMD device 1000. For example, the prestored panorama image may include an image obtained through a 360-degree camera that is able to simultaneously capture an image of the entire real environment or a panorama camera that is able to capture an image of the real environment with an FOV wider than an FOV of the original image. In another example, the prestored panorama image may include a panorama image generated based on images captured of the real environment at various angles while changing the shooting angle of the stereo camera of the HMD display 1000. In an embodiment of the disclosure, the HMD device 1000 may identify a point at which the user is gazing or looking in a 3D space. In an embodiment of the disclosure, the HMD device 1000 may extract an area in the panorama image corresponding to the point at which the user is gazing or looking, and obtain an image of the extracted area as an original image.

In operation S220, the HMD device 1000 may detect at least one object included in the original image. In an embodiment of the disclosure, Based on the obtained original image, the HMD device 1000 may identify a class and location of each of the at least one object included in the original image. The class may include a category or label that indicates a type of the object to be identified in the image. Furthermore, the location of the object may include a location of an area corresponding to the object in the original image.

In an embodiment of the disclosure, the HMD device 1000 may detect at least one object included in the original image by applying the original image to an object detection model. The object detection model may include an AI model that uses an image as an input and identifies the class and location of an object included in the image.

In an embodiment of the disclosure, the object detection model may output location information of a bounding box that encloses surroundings of an object detected from the input image and class information of the object located in the bounding box as object detection results. In an embodiment of the disclosure, the object detection model may be trained based on an image for training that includes various classes of objects and metadata for training that corresponds to the image for training. In an embodiment of the disclosure, the metadata for training may include location information of a bounding box that encloses an object included in the image for training and class information of the object.

In an embodiment of the disclosure, the HMD device 1000 may detect at least one object included in the original image by applying the original image to a segmentation model. The segmentation model may include an AI model that allocates each of a plurality of pixels included in an image input to the segmentation model to one of a plurality of preset classes.

In an embodiment of the disclosure, the segmentation model may include a semantic segmentation model and an instance segmentation model. The semantic segmentation model may output a segmentation map as an object detection result in which the plurality of pixels of the input image are allocated unique values differentiated by the plurality of preset classes. The instance segmentation model may output a segmentation map as an object detection result in which the plurality of pixels of the input image are differentiated by the plurality of preset classes and allocated unique values differentiated by different objects of the same class. In an embodiment of the disclosure, the HMD device 1000 may detect at least one object included in the original image by classifying pixels allocated the same value in the segmentation map.

In an embodiment of the disclosure, the segmentation model may be trained based on images for training that include various classes of objects and segmentation maps for training that correspond to the images for training. In an embodiment of the disclosure, the segmentation map for training input to the semantic segmentation model may have the plurality of pixels allocated unique values differentiated by the plurality of preset classes. In an embodiment of the disclosure, the segmentation map for training input to the instance segmentation model may have the plurality of pixels differentiated by a plurality of classes and allocated unique values differentiated by different objects of the same class.

In an embodiment of the disclosure, the HMD device 1000 may trace the detected at least one object. The tracing of the object may refer to continuously detecting a certain object from a plurality of frames and identifying a change in location of the detected object. The HMD device 1000 may perform object tracing by assigning a unique ID to an object detected from each of the plurality of frames included in the original image and identifying a change in location of the object assigned the same ID.

In an embodiment of the disclosure, the HMD device 1000 may trace the detected at least one object by applying the object detection result obtained from the object detection model to an object tracing model. In an embodiment of the disclosure, the object tracing model may include a rule-based algorithm model or an AI model that assigns a unique ID for each detected object based on the object detection result and identifies a change in location of the object. In an embodiment of the disclosure, the object tracing model may include a sub-model that is able to obtain the aforementioned object detection model or object detection result. In this case, the object tracing model may detect an object based on a plurality of frame images as inputs and simultaneously, trace the detected object.

In an embodiment of the disclosure, the object tracing model may output location change information of an object traced based on the object detection result or the plurality of frame images and identification information of the traced object as a tracing result. In an embodiment of the disclosure, the object tracing model may be trained based on an image for training that includes various classes of objects and metadata for training that corresponds to the image for training. In an embodiment of the disclosure, the metadata for training input to the object tracing model may include location information of a bounding box that encloses an object included in a plurality of frames of the image for training, a class of the object and a unique ID assigned for each object.

In an embodiment of the disclosure, the HMD device 1000 may obtain an outer view image that represents the second FOV wider than the first FOV of the original image. As the outer view image is an image that represents the second FOV wider than the first FOV of the original image, an object that is not included in the original image may be included in the outer view image.

In an embodiment of the disclosure, the HMD device 1000 may obtain the original image captured with the first FOV through the stereo camera included in the HMD device 1000 and obtain the outer view image captured with the second FOV through the sub-camera included in the HMD device 1000. In an embodiment of the disclosure, the sub-camera may include a plurality of cameras for capturing an image of a hand of the user or capturing an image of a real environment (e.g., the hand of the user) outside the first FOV. In this case, the HMD device 1000 may obtain the outer view image based on images obtained from the plurality of cameras. In another example, the sub-camera may include a wide-angle camera that is able to capture an image with the second FOV wider than the first FOV.

In an embodiment of the disclosure, the HMD device 1000 may obtain the captured original image from the prestored panorama images, and obtain the outer view image captured with the second FOV by extracting a certain portion of a panorama image that represents the first FOV from the prestored panorama images.

In an embodiment of the disclosure, based on the original image and the outer view image, the at least one object moving in and out of the first FOV may be traced. In an embodiment of the disclosure, the HMD device 1000 may detect at least one object from the outer view image and trace the detected at least one object. The operations of the HMD device 1000 for detecting an object from an outer view image and tracing the object correspond to the aforementioned operations of detecting an object from the original image and tracing the object, so the overlapping description will not be repeated.

In an embodiment of the disclosure, the HMD device 1000 may trace at least one object moving in and out of the first FOV based on a result of tracing the at least one object obtained from the original image and a result of tracing the at least one object obtained from the outer view image. In an embodiment of the disclosure, the HMD device 1000 may trace at least one object moving in and out of the first FOV, and include at least one piece of information about whether the at least one object detected outside the first FOV is one detected previously from the original image and about a moving direction of the object.

For example, the HMD device 1000 may assign the same unique ID to an object traced from the original image and an object traced from the outer view image. Accordingly, even though the object located in the first FOV moves out of the first FOV, the existing tracing may be maintained based on a result of tracing the object obtained from the outer view image. When an object is detected from outside the first FOV, whether the object corresponds to an object detected from the original image based on a result of tracing the object obtained from the original image.

In an embodiment of the disclosure, the HMD device 1000 may display a user interface that indicates identification information of at least one object located outside the first FOV. In an embodiment of the disclosure, the identification information may include a result of tracing or detecting at least one object moving between inside and outside of the first FOV. For example, when an object located in the first FOV moves to the left of the first FOV and is detected outside the first FOV of the outer view image, the HMD device 1000 may display an indicator indicating that the object has moved to the left on the original image. In another example, when a new object that has never been detected from the original image is detected outside the first FOV of the outer view image, an indicator indicating that the new object has been detected may be displayed on the original image. It is not, however, limited thereto, and the identification information may also include information about a class and location of at least one object located outside the first FOV.

In operation S230, the HMD device 1000 may obtain depth information of the detected at least one object by using the original image. In an embodiment of the disclosure, the depth information may include information representing depth information of the object or background of the 3D space in a 2D image. For example, the depth information may include a depth map corresponding to a plurality of frames of the original image. It is not, however, limited thereto, and the depth information may include a distance of each of the detected at least one object to the HMD device 1000.

In an embodiment of the disclosure, the HMD device 1000 may obtain depth information of the detected at least one object by applying the original image to a depth estimation model. In an embodiment of the disclosure, the depth estimation model may include an AI model that outputs, based on an image as an input, a depth map corresponding to the input image. In an embodiment of the disclosure, the depth estimation model may be trained based on images for training and ground truth depth maps corresponding to the images for training.

In an embodiment of the disclosure, the HMD device 1000 may obtain depth information of the detected at least one object based on stereo images. In an embodiment of the disclosure, the HMD device 1000 may obtain stereo images of the original image, and calculate disparity between the obtained stereo images. In an embodiment of the disclosure, the HMD device 1000 may generate a depth map of the original image by calculating depth values of the plurality of pixels based on the calculated disparity.

In an embodiment of the disclosure, the HMD device 1000 may obtain depth information of at least one object based on data obtained based on a distance detection sensor. In an embodiment of the disclosure, the distance detection sensor may measure distances between objects in a real environment where the original image is captured and the distance detection sensor. In an embodiment of the disclosure, the HMD device 1000 may generate a depth map of the original image by mapping the data obtained from the distance detection sensor to a plurality of pixels included in the original image.

In operations S240, the HMD device 1000 may identify a target object from among the detected at least one object based on the depth information.

In an embodiment of the disclosure, the HMD device 1000 may identify at least one object located in a preset distance range from the HMD device among the detected at least one object based on the depth information. In an embodiment of the disclosure, the HMD device 1000 may calculate an average of depth values of the plurality of pixels corresponding to the detected at least one object included in the depth map, and identify at least one object having a distance corresponding to the calculated average of depth values within the preset distance range. It is not, however, limited thereto, and the HMD device 1000 may identify at least one object located within the preset distance range based on whether a distance corresponding to a maximum value or a minimum value of the plurality of pixels corresponding to the detected at least one object included in the depth map is within the preset distance range.

In an embodiment of the disclosure, the HMD device 1000 may determine the preset distance range based on a user input. For example, the HMD device 1000 may obtain, but not exclusively, a user input to determine the preset distance range to be a first distance or less, determine the preset distance range to be a second distance or more, or determine the preset distance range to be from the first distance to a second distance.

In an embodiment of the disclosure, the HMD device 1000 may display a virtual object. The virtual object may be an object that exists in a virtual environment of the 3D space, which may be located in the 3D space. In an embodiment of the disclosure, the HMD device 1000 may create a 3D space including at least one object detected from the original image based on depth information of the at least one object detected from the original image. In an embodiment of the disclosure, the HMD device 1000 may map the virtual object onto the created 3D space. In an embodiment of the disclosure, the HMD device 1000 may display the virtual object on the original image or the inpainted image based on the location at which the virtual object is mapped into the 3D space.

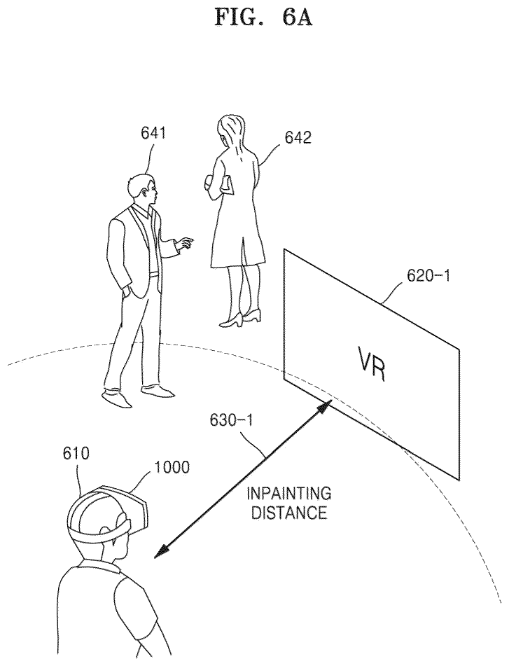

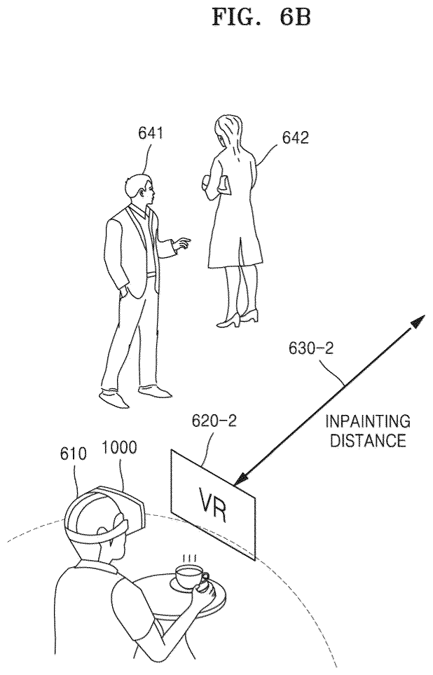

In an embodiment of the disclosure, the HMD device 1000 may determine the preset distance range based on the virtual object. A detailed description of how the HMD device 1000 determines the preset distance range based on the virtual object will be described later in connection with FIGS. 6A and 6B.

In an embodiment of the disclosure, the HMD device 1000 may determine a target object among at least one object identified as being located within the preset distance range.

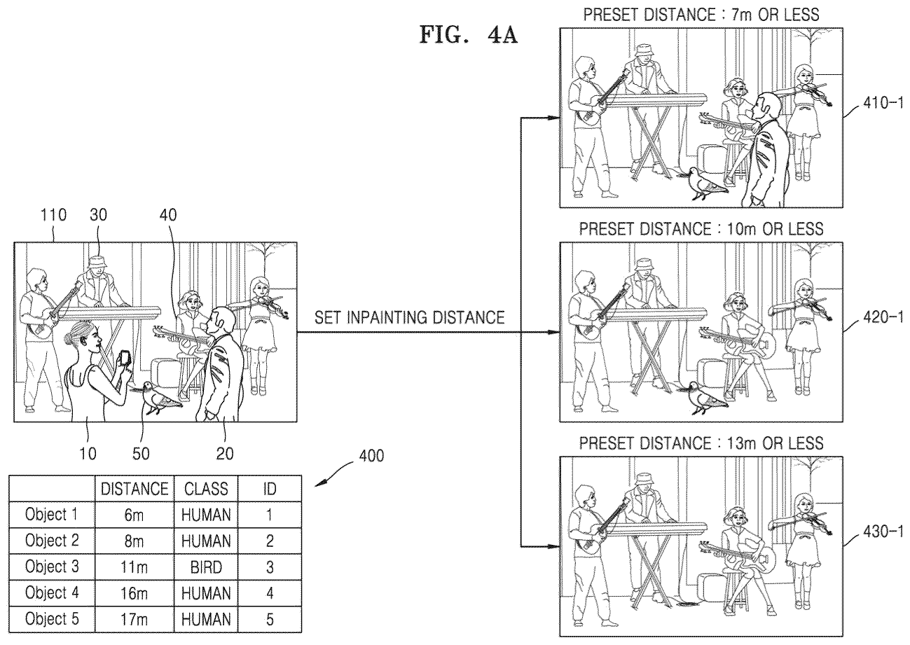

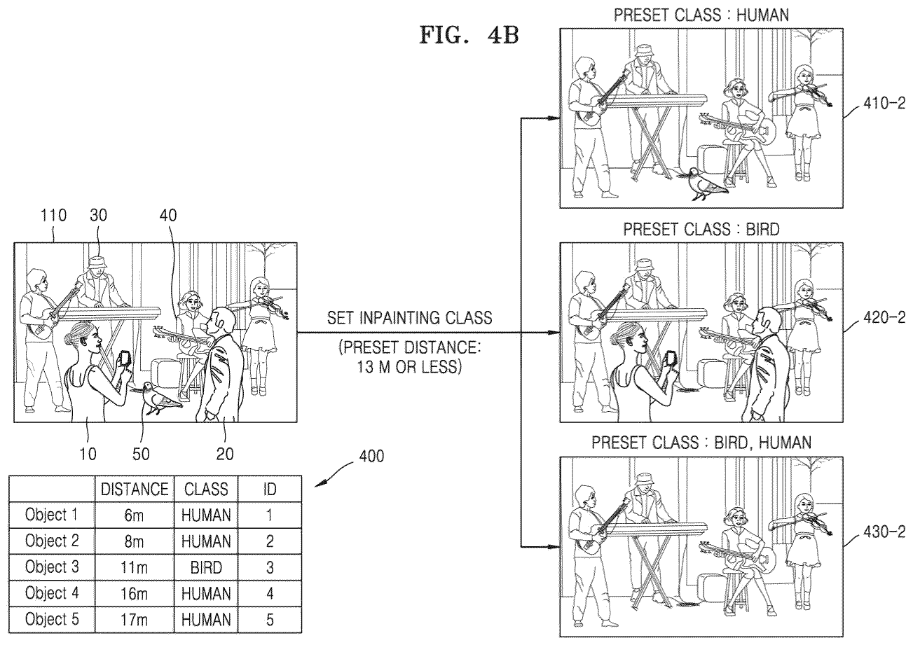

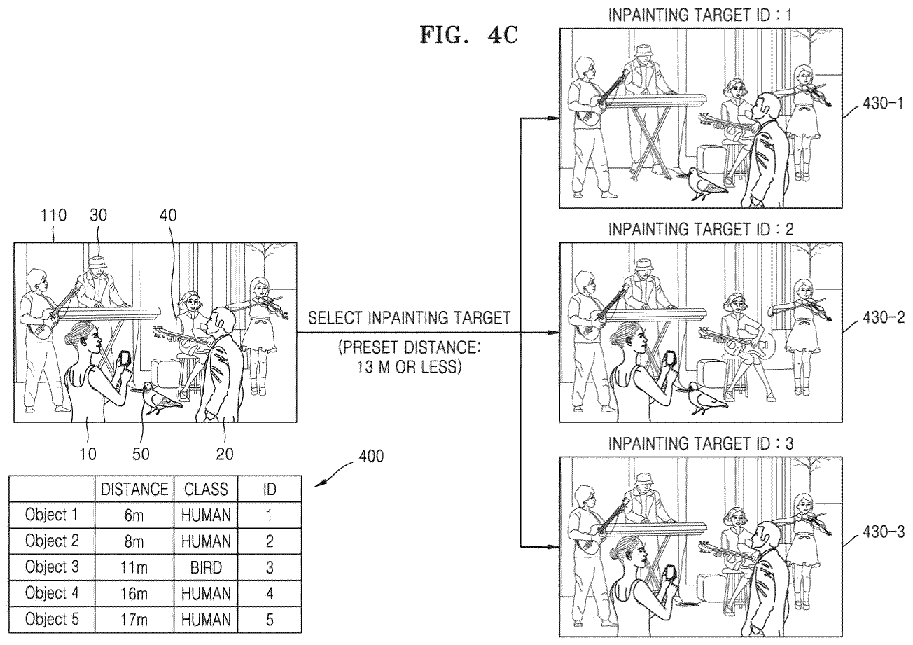

In an embodiment of the disclosure, the HMD device 1000 may determine an object classified into a preset class among the at least one object identified as being located within the preset distance range as the target object. In an embodiment of the disclosure, the HMD device 1000 may determine an object selected as an inpainting target among the at least one object identified as being located within the preset distance range as the target object. A detailed description of how the HMD device 1000 determines a target object among the at least one object identified as being located within the preset distance range will be described later in connection with FIGS. 4A, 4B and 4C.

In operation S250, the HMD device 1000 may inpaint a region corresponding to the identified target object in the original image. In an embodiment of the disclosure, The HMD device 1000 may obtain an inpainted image where an area corresponding to the target object is reconstructed (restored) in the original image by inpainting the target object based on the original image. The reconstructed area may refer to the area corresponding to the target object in the original image, that is inpainted to an area estimated as being observed when the target object does not exist in the real environment.

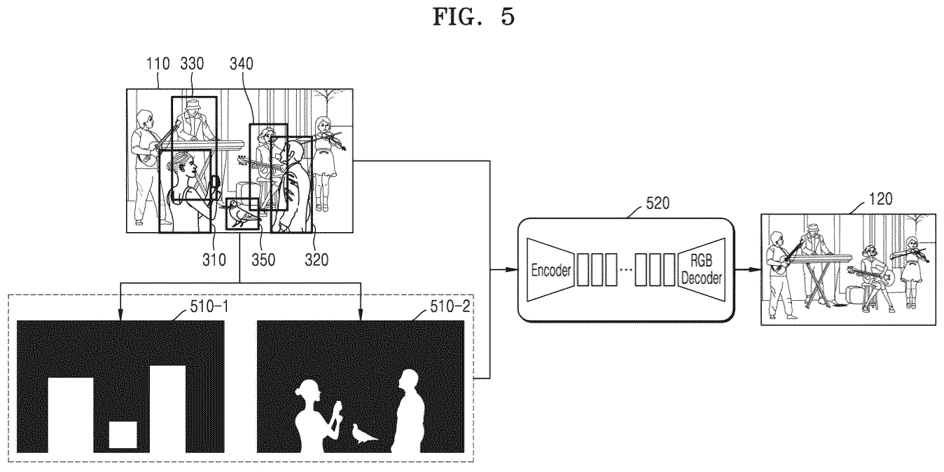

In an embodiment of the disclosure, the HMD device 1000 may obtain a mask map that represents the area corresponding to the target object in the original image. In an embodiment of the disclosure, the HMD device 1000 may obtain the inpainted image by applying the original image and the mask map to an inpainting model for inpainting the target object. In an embodiment of the disclosure, based on an image and a mask map corresponding to the image, the inpainting model may include an AI model for inpainting an area represented by the mask map in the image. In an embodiment of the disclosure, based on an image and a mask map corresponding to the image, the inpainting model may output an image including an area where the area represented by the mask map is inpainted. A detailed description of the mask map that represents an area corresponding to the target object will be described later in connection with FIG. 5.

In an embodiment of the disclosure, the inpainting model may perform inpainting, based on spatial characteristics included in a single image, such that the area represented by the mask map is matched with a context in the image. The inpainting model may convert pixels in an area corresponding to the target object in the original image to have similar values (e.g., colors, textures) to adjacent pixels, thereby preventing the inpainted image from including unnatural boundaries or patches. In an embodiment of the disclosure, the inpainting model may perform inpainting, based on temporal characteristics obtained from successive frames, to be matched to a motion occurring between adjacent frame images. The inpainting model may convert the pixels in an area corresponding to the target object in the original image to have values matched to a motion occurring between adjacent frames, thereby preventing the motion in the inpainted image from being seen unnaturally. In an embodiment of the disclosure, the inpainting model may be trained based on an image for training, a mask map corresponding to the image for training and a ground truth image where an area represented by the mask map is removed from the image for training.

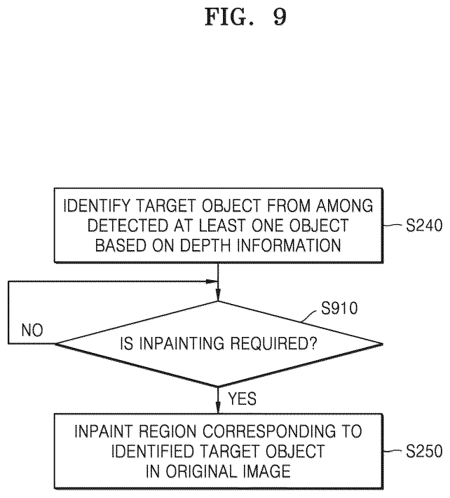

In an embodiment of the disclosure, the HMD device 1000 may identify whether inpainting is required for the target object, and inpaint the region corresponding to the identified target object based on identifying that the inpainting is required. A detailed description of how the HMD device 1000 performs inpainting based on a situation where inpainting is required will be described later in connection with FIG. 9.

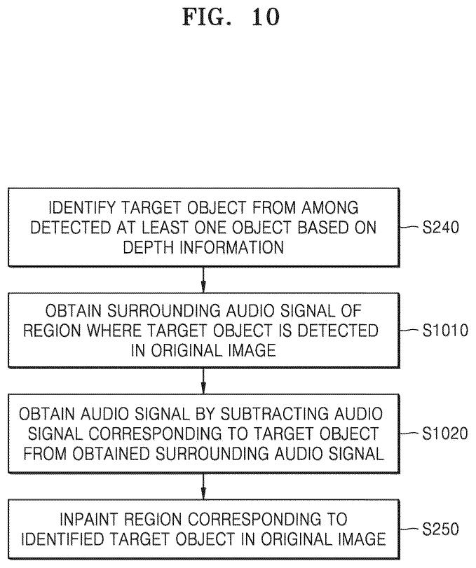

In an embodiment of the disclosure, the HMD device 1000 may obtain a surrounding audio signal of a region where the determined target object is detected in the original image, and obtain an audio signal by subtracting an audio signal corresponding to the target object from the obtained surrounding audio signal. A detailed description of how the HMD device 1000 obtains an audio signal obtained by subtracting the audio signal corresponding to the target object will be described later in connection with FIG. 10.

In operation S260, the HMD device 1000 may display the inpainted image. In an embodiment of the disclosure, the HMD device 1000 may display the original image before inpainting mode is activated, and display the inpainted image instead of the original image after the inpainting mode is activated. In an embodiment of the disclosure, the HMD device 1000 may obtain a user input for controlling activation of the inpainting mode and determine activation of the inpainting mode based on the user input. It is not, however, limited thereto, and the HMD device 1000 may display the original image or the inpainted image based on whether inpainting is required for the target object.

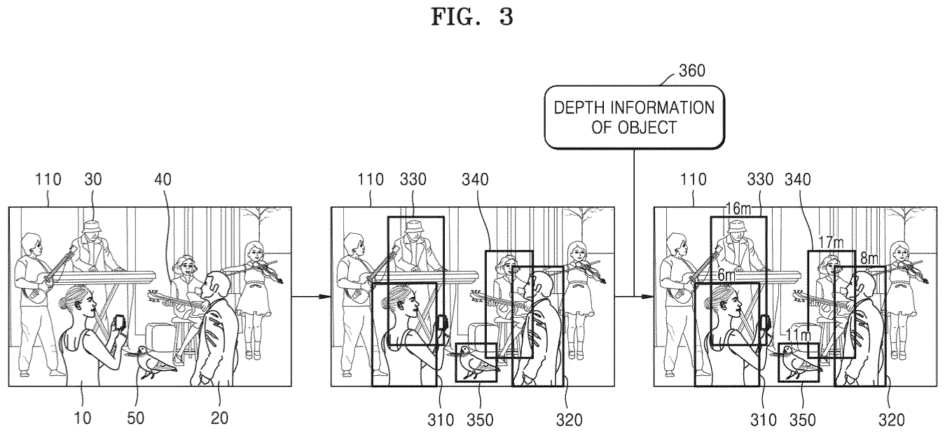

FIG. 3 is a diagram for describing operations of an HMD device for detecting an object and identifying a distance from the HMD device to the object, according to an embodiment of the disclosure.

In an embodiment of the disclosure, the HMD device 1000 may obtain the original image 110. The original image 110 is an image obtained by capturing an image of a real environment, which may include various objects that exist in the real environment. In an embodiment of the disclosure, the original image 110 may include various objects that exist in the real environment. For example, the original image 110 may include the first person 10, second person 20, third person 30, fourth person 40 and pigeon 50, which exist in the photographed real environment.

In an embodiment of the disclosure, the HMD device 1000 may detect at least one object included in the original image 110. For example, by detecting the at least one object included in the original image 110, the HMD device 1000 may identify the class of the first person 10, second person 20, third person 30 and fourth person 40 as ‘human’ and the class of the pigeon 50 as ‘bird’. By detecting the at least one object included in the original image 110, the HMD device 1000 may identify areas corresponding to the first person 10, second person 20, third person 30, fourth person 40 and pigeon 50 as a first bounding box 310, a second bounding box 320, a third bounding box 330, a fourth bounding box 340 and a fifth bounding box 350. It is not, however, limited thereto, and the areas corresponding to the first person 10, second person 20, third person 30, fourth person 40 and pigeon 50 may be identified in pixels with respect to the boundaries of the respective objects.

In an embodiment of the disclosure, the HMD device 1000 may trace the at least one object detected in the original image 110. In an embodiment of the disclosure, by applying the original image 110 to an object tracing model, the HMD device 1000 may trace the detected at least one object and identify a change in location of the detected at least one object. For example, by tracing the at least one object detected in the original image 110, the HMD device 1000 may assign unique IDs to the first person 10, second person 20, third person 30, fourth person 40 and pigeon 50, respectively, and identify a change in location of the object assigned the same ID between successive frames of the original image 110.

In an embodiment of the disclosure, the HMD device 1000 may obtain depth information 360 of the at least one object included in the original image 110. In an embodiment of the disclosure, the HMD device 1000 may identify a distance of the at least one object detected from the original image 110 to the HMD device 1000 based on the obtained depth information 360. For example, the depth information 360 may include a depth map of the original image 110. The HMD device 1000 may identify distances of the first person 10, second person 20, third person 30, fourth person and pigeon 50 to the HMD device as ‘6 m’, ‘8 m’, ‘16 m’, ‘17 m’ and ‘11 m’, respectively, based on depth values of areas corresponding to the respective first person 10, second person 20, third person 30, fourth person 40 and pigeon 50 in the depth map.

FIGS. 4A, 4B and 4C are diagrams for describing an operation of an HMD device for determining an inpainting target, according to an embodiment of the disclosure.

In an embodiment of the disclosure, the HMD device 1000 may obtain object recognition information 400. The object recognition information 400 may include detection results and tracing results of the at least one object included in the original image 110. For example, the object recognition information 400 may include information about a location, class, and unique ID of the at least one object detected from the original image 110. The object recognition information 400 may include a distance of the at least one object detected from the original image 110 to the HMD device 1000. In an embodiment of the disclosure, the HMD 1000 may sequentially obtain detection results and tracing results of the at least one object included in each of the plurality of frames of the original image 110, and update the object recognition information 400.

In an embodiment of the disclosure, the HMD device 1000 may determine a target object based on the object recognition information 400.

Referring to FIG. 4A, the HMD device 1000 may determine a preset distance range to determine a target object. For example, the HMD device 1000 may determine the preset distance range to be ‘7 m or less’, ‘10 m or less’ or ‘13 m or less’.

In an embodiment of the disclosure, the HMD device 1000 may identify an object located in the preset distance range from the HMD device 1000 among the at least one object detected from the original image 110, and determine the identified object as the target object.

For example, when the preset distance range is ‘7 m or less’, the HMD device 1000 may determine the first person 10 at a distance of 6 m from the HMD device 1000 as the target object based on the object recognition information 400. The HMD device 1000 may then obtain an inpainted image 410-1 by inpainting the first person 10 determined as the target object in the original image 110. The inpainted image 410-1 may include a reconstructed area obtained by inpainting an area corresponding to the first person 10 in the original image 110. Specifically, the inpainted image 410-1 may include part of the background such as the street, building, etc., and the third person 30 blocked by the first person 10 in the real environment in which the original image 110 is captured.

In another example, when the preset distance range is ‘10 m or less’, the HMD device 1000 may determine the first person 10 at a distance of 6 m and the second person 20 at a distance of 8 m from the HMD device 1000 as the target objects based on the object recognition information 400. The HMD device 1000 may then obtain an inpainted image 420-1 by inpainting the first person 10 and the second person 20 determined as the target objects in the original image 110. The inpainted image 420-1 may include a reconstructed area obtained by inpainting an area corresponding to the first person 10 and an area corresponding to the second person 20 in the original image 110. Specifically, the inpainted image 420-1 may include part of the background such as the street, building, etc., the third person 30 and the fourth person 40 blocked by the first person 10 and the second person 20 in the real environment of which the original image 110 is captured.

In another example, when the preset distance range is ‘13 m or less’, the HMD device 1000 may determine the first person 10 at a distance of 6 m, the second person 20 at a distance of 8 m and the pigeon at a distance of 11 m from the HMD device 1000 as the target objects based on the object recognition information 400. The HMD device 1000 may then obtain an inpainted image 430-1 by inpainting the first person 10, the second person 20 and the pigeon 50 determined as the target objects in the original image 110. The inpainted image 430-1 may include a reconstructed area obtained by inpainting an area corresponding to the first person 10, an area corresponding to the second person 50 and an area corresponding to the pigeon 50 in the original image 110. Specifically, the inpainted image 430-1 may include part of the background such as the street, building, etc., the third person 30, the fourth person 40 and instrument played by the fourth person 40 blocked by the first person 10, the second person 20 and the pigeon 50 in the real environment of which the original image 110 is captured.

Referring to FIG. 4B, the HMD device 1000 may identify an object located in the preset distance range from the HMD device 1000 among the at least one object detected from the original image, and determine an object classified into a preset class as the target object among the identified at least one object.

In an embodiment of the disclosure, the HMD device 1000 may determine the preset class based on a user input. In an embodiment of the disclosure, the HMD device 1000 may obtain a user input that selects the preset class. For example, the HMD device 1000 may display a user interface representing a plurality of classes that may be detected by the object detection model, and obtain a user input to select at least one of the displayed plurality of classes as an inpainting class. In another example, the HMD device 1000 may display a user interface representing a plurality of classes of a plurality of objects detected from at least one of the original image or the outer view image. The HMD device 1000 may obtain a user input to select at least one of the plurality of classes displayed through the user interface, and determine the selected at least one class as the preset class. It is not, however, limited thereto, and the preset class may include a class set in advance regardless of the user input.

How the HMD device 1000 determines a target object based on the preset class when the preset distance range is 13 m or less and the first person 10, second person 20 and pigeon 50 are identified as objects located within the preset distance range from the HMD device 1000 will now be described in connection with FIG. 4B.

For example, when the preset class is ‘human’, the HMD device 1000 may determine the first person 10 and second person 20 whose class is ‘human’ as target objects from among the first person 10, second person 20 and pigeon 50 based on the object recognition information 400. The HMD device 1000 may then obtain an inpainted image 410-2 by inpainting the first person 10 and the second person 20 determined as the target objects in the original image 110.

In another example, when the preset class is ‘bird’, the HMD device 1000 may determine the pigeon 50 whose class is ‘bird’ as the target object from among the first person 10, second person 20 and pigeon 50 based on the object recognition information 400. The HMD device 1000 may then obtain an inpainted image 410-2 by inpainting the pigeon 50 determined as the target object in the original image 110.

In another example, when the preset class is ‘bird’, the HMD device 1000 may determine the pigeon 50 whose class is ‘bird’ as the target object from among the first person 10, second person 20 and pigeon 50 based on the object recognition information 400. The HMD device 1000 may then obtain an inpainted image 420-2 by inpainting the pigeon 50 determined as the target object in the original image 110.

For example, when the preset class is ‘human and bird’, the HMD device 1000 may determine the first person 10 and second person 20 whose classes are ‘human’ and the pigeon 50 whose class is ‘bird’ as target objects from among the first person 10, second person 20 and pigeon 50 based on the object recognition information 400. The HMD device 1000 may then obtain an inpainted image 430-2 by inpainting the first person 10, second person 20 and pigeon 50 determined as the target objects in the original image 110.

Referring to FIG. 4C, the HMD device 1000 may identify an object located in the preset distance range from the HMD device 1000 among the at least one object detected from the original image 110, and determine an object selected as an inpainting target from among the identified at least one object as a target object. In an embodiment of the disclosure, the HMD device 1000 may identify an ID of the object selected as an inpainting target based on the object recognition information 400, and determine an object assigned the identified ID among the at least one object detected from the original image 110 as the target object.

In an embodiment of the disclosure, the HMD device 1000 may select an inpainting target based on a user input. A user input to select at least one of the detected at least one object as the inpainting target may be obtained. For example, the HMD device 1000 may display a user interface representing the plurality of objects detected from at least one of the original image or the outer view image, and obtain a user input to select at least one of the displayed plurality of objects as an inpainting target. In an embodiment of the disclosure, the HMD device 1000 may select an object located outside the first FOV and detected only from the outer view image as the inpainting target. When the selected target object moves into the first FOV, the HMD device 1000 may identify the object selected as the inpainting target among at least one object included in the original image based on a result of tracing the object obtained from the outer view image and a result of tracing the object obtained from the original image.

How the HMD device 1000 determines a target object based on the inpainting target when the preset distance range is 13 m or less and the first person 10, second person 20 and pigeon 50 are identified as objects located within the preset distance range from the HMD device 1000 will now be described in connection with FIG. 4C.

For example, when the inpainting target is selected to be the first person 10, the HMD device 1000 may determine the first person 10 whose ID is ‘1’ as a target object among the first person 10, second person 20 and pigeon 50 based on the object recognition information 400. The HMD device 1000 may then obtain an inpainted image 410-3 by inpainting the first person 10 determined as the target object in the original image 110.

In another example, when the inpainting target is selected to be the second person 20, the HMD device 1000 may determine the second person 10 whose ID is ‘2’ as a target object among the first person 10, second person 20 and pigeon 50 based on the object recognition information 400. The HMD device 1000 may then obtain an inpainted image 420-3 by inpainting the second person 20 determined as the target object in the original image 110.

In another example, when the inpainting target is selected to be the pigeon 50, the HMD device 1000 may determine the pigeon 50 whose ID is ‘5’ as the target object from among the first person 10, second person 20 and pigeon 50 based on the object recognition information 400. The HMD device 1000 may then obtain an inpainted image 430-3 by inpainting the pigeon 50 as the target object in the original image 110.

In another example, when the inpainting target is selected to be the third person 30 or the fourth person 40, the HMD device 1000 may not determine the third person 30 and the fourth person 40 as the target object because the third person 30 or the fourth person 40 is an object that is not located at a distance of 13 m or less from the HMD device 1000. In an embodiment of the disclosure, when the object recognition information 400 is updated that the third person 30 or the fourth person 40 selected as the inpainting target is located at a distance of 13 m or less from the HMD device 1000, the HMD device 1000 may determine the target object to be the third person 30 or the fourth person 40 selected as the inpainting target.

FIG. 5 is a diagram for describing a mask map, according to an embodiment of the disclosure.

In an embodiment of the disclosure, the HMD device 1000 may obtain a mask map 510 that represents an area corresponding to the target object in the original image 110. The mask map 510 representing the area corresponding to the target object may be represented with binary data: pixel values of the area corresponding to the target object are ‘1’ and pixel values of areas except for the area corresponding to the target object are ‘0’. It is not, however, limited thereto, and the binary data values may be the other way around, or it may be represented in a different data format instead of the binary data.

For example, by detecting the at least one object included in the original image 110, the HMD device 1000 may identify the first bounding box 310, the second bounding box 320, the third bounding box 330, the fourth bounding box 340 and the fifth bounding box 350 enclosing the first person 10, the second person 20, the third person 30, the fourth person 40 and the pigeon 50, respectively. In this case, when the first person 10, second person 20 and pigeon 50 are target objects, the HMD device 1000 may obtain a first mask map 510-1 representing the first bounding box 310, second bounding box 320 and fifth bounding box 330.

In another example, by detecting at least one object included in the original image 110, the HMD device 1000 may identify a plurality of pixels included within the boundaries of the respective first person 10, second person 20, third person 30, fourth person 40 and pigeon 50. In this case, when the first person 10, second person 20 and pigeon 50 are target objects, the HMD device 1000 may obtain a second mask map 510-1 representing the first person 10, second person 20 and pigeon 50.

In an embodiment of the disclosure, the HMD device 1000 may obtain an inpainted image 120 by applying the original image 110 and the mask map 510 representing an area corresponding to a target object to an inpainting model 520 for inpainting the target object. For example, the HMD device 1000 may input the original image 110, and the first mask map 510-1 or the second mask map 510-2 to the inpainting model 520, and obtain the inpainted image 120 from the inpainting model 520. The inpainted image 120 may include an area obtained by reconstructing the area represented by the first mask map 510-1 or the area represented by the second mask map 510-2 in the original image 110.

In an embodiment of the disclosure, the inpainting model 520 may include an encoder 521 and a plurality of neural network layers. In an embodiment of the disclosure, the encoder may output a feature map of a plurality of frames based on an input image. The feature map of the plurality of frames may include various features such as color, texture, shape, etc., of the plurality of frames. In an embodiment of the disclosure, the plurality of neural network layers may include various layers such as a convolution neural network layer, an attention layer for performing an attention mechanism, etc. Based on the feature map output from the encoder, the plurality of neural network layers may output a feature map of the plurality of frames where the area represented by the mask map is reconstructed by extracting a spatial feature, a temporal feature and context information of the plurality of frames. In an embodiment of the disclosure, a decoder may output the inpainted image 120 based on the feature map of the plurality of frames where the area represented by the mask map is reconstructed.

FIGS. 6A and 6B are diagrams for describing a preset distance determined based on a virtual object, according to an embodiment of the disclosure.

In an embodiment of the disclosure, the HMD device 1000 may display a virtual object 620-1 or 620-2. For example, the HMD device 1000 may obtain an original image including a first person 641 and a second person 642 that exist in the real environment. The HMD device 1000 may create a 3D space including the first person 641 and the second person 642 based on depth information of the first person 641 and the second person 642. The HMD device 1000 may map the virtual object 620-1 or 620-2 onto the created 3D space, and display the virtual object 620-1 or 620-2 on the original image or the inpainted image based on where the virtual object 620-1 or 620-2 are mapped.

In an embodiment of the disclosure, the HMD device 1000 may determine a preset distance range based on the virtual object 620-1 or 620-2.

In an embodiment of the disclosure, the HMD device 1000 may determine the preset distance range based on a distance between the virtual object 620-1 or 620-2 and the HMD device 1000. For example, the HMD device 1000 may calculate the distance between the virtual object 620-1 or 620-2 and the HMD device 1000 based on coordinates of the HMD device 1000 and coordinates of the virtual object 620-1 or 620-2 in the 3D space. Based on the calculated distance, a distance value of the preset distance range may be determined.

In an embodiment of the disclosure, the HMD device 1000 may determine the preset distance range based on the type of the virtual object 620-1 or 620-2. For example, the type of the virtual object 620-1 or 620-2 may include a first type that is located and displayed at a far distance from the user (or long-distance display type), a second type that is located and displayed at a certain distance from the user (or medium-distance display type) and a third type that is located and displayed at a near distance from the user (or short-distance display type). When the virtual object is the first type, the HMD device 1000 may determine a distance between a location at a first distance from the HMD device 1000 and the virtual object as the preset distance range. When the virtual object is the second type, a distance between the HMD device 1000 and the virtual object as the preset distance range. When the virtual object is the third type, a distance farther than the virtual object may be determined as the preset distance range. It is not, however, limited thereto, and the type of the virtual object 620-1 or 620-2 may be determined based on the content provided by the virtual object 620-1 or 620-2 or determined based a user input. Moreover, the method of determining the preset distance range may depend on the type of the virtual object 620-1 or 620-2.

Referring to FIG. 6A, the virtual object 620-1 may be a type, according to which the distance from the HMD device 1000 to the virtual object 620-1 is determined as a preset distance range 630-1. For example, the virtual object 620-1 may be a screen on which a film is displayed. In this case, the HMD device 1000 may compute the distance between the HMD device 1000 and the virtual object 620-1 to be 13 m, and determine the preset distance range 630-1 to be “13 m or less”. The HMD device 1000 may then determine the first person 641 located within a range of 13 m or less from the HMD device 1000 as the target object, and may not determine the second person 642 not located within the range of 13 m or less as the target object. The first person 641 that may block the virtual object 620-1 may be a hindering element for the user 610 to watch the virtual object 620-1, and may thus be determined as the target object. The second person 642 located behind the virtual object 620-2 may not be a hindering element for the user 610 to watch the virtual object 620-1, and may thus not be determined as the target object.

Referring to FIG. 6B, the virtual object 620-2 may be a type, according to which a distance farther than the virtual object 620-1 is determined as a preset distance range 630-2. For example, the virtual object 620-2 may be a screen on which a working document is displayed. In this case, the HMD device 1000 may compute the distance between the HMD device 1000 and the virtual object 620-1 to be 0.5 m, and determine the preset distance range 630-2 to be “more than 0.5 m”. The HMD device 1000 may then determine the first person 641 and the second person 642 located in a range of more than 0.5 m from the HMD device 1000 as target objects. An object (e.g., a cup, a table, a laptop, etc.) in a real environment located between the user 610 and the virtual object 620-2 is not a hindering element for the user 610 to do a task related to the virtual object 620-2, and may thus not be determined as the target object. The first person 641 and the second person 642 located behind the virtual object 620-2 may be a hindering element for the user 610 to do the task related to the virtual object 620-2, and may thus be determined as the target object.

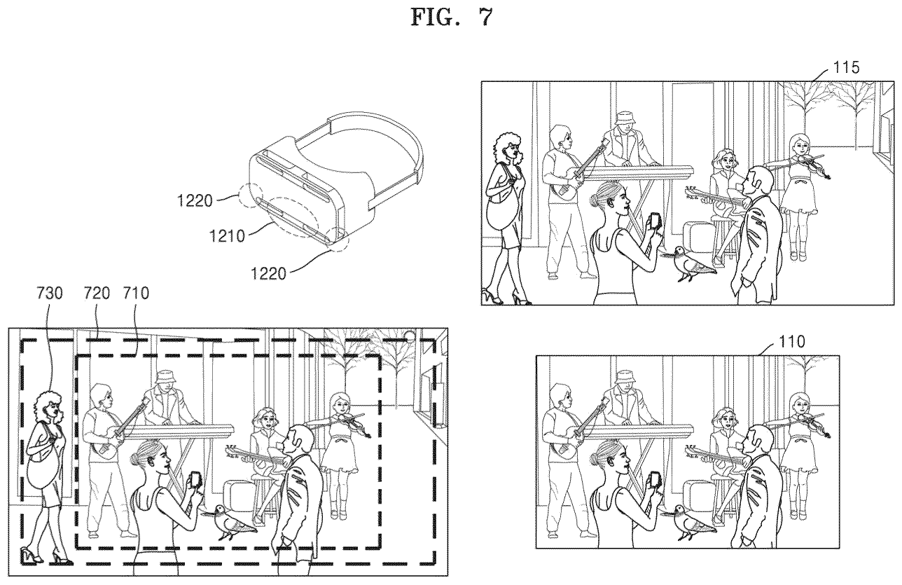

FIG. 7 is a diagram for describing a first FOV of an original image and a second FOV of an outer view image, according to an embodiment of the disclosure.

In an embodiment of the disclosure, the HMD device 1000 may obtain the original image 110 representing a first FOV 710. In an embodiment of the disclosure, the HMD device 1000 may include a stereo camera 1210. In an embodiment of the disclosure, the stereo camera 1210 may obtain an image including an object located within the first FOV 710 by capturing an image of the real environment with the first FOV 710. In an embodiment of the disclosure, the HMD device 1000 may obtain the original image 110 based on the image obtained through the stereo camera 1210.

In an embodiment of the disclosure, the HMD device 1000 may obtain the outer view image 115 representing a second FOV 720. In an embodiment of the disclosure, the HMD device 1000 may include a sub-camera 1220. In an embodiment of the disclosure, the sub-camera 1220 may obtain an image including an object located within the second FOV 720 wider than the first FOV 710 by capturing an image of the real environment with the second FOV 720. In an embodiment of the disclosure, the HMD device 1000 may obtain the outer view image 115 based on the image obtained through the sub-camera 1220.

In an embodiment of the disclosure, the HMD device 1000 may trace at least one object moving in and out of the first FOV 710 based on the original image 110 and the outer view image 115.

For example, the HMD device 1000 may obtain information indicating that a person 730 is a new object that has not previously been detected from the original image 110 and that is moving into the first FOV 710, based on a result of tracing the person 730 obtained from the original image 110 and a result of tracing the person 730 obtained from the outer view image 115. In another example, the HMD device 1000 may obtain information indicating that the person 730 is an object that has been previously detected from the original image 110 and that is moving out of the first FOV 710, based on a result of tracing the person 730 obtained from the original image 110 and a result of tracing the person 730 obtained from the outer view image 115.

In an embodiment of the disclosure, the HMD device 1000 may display a user interface that indicates identification information of at least one object located outside the first FOV 710. The user may not recognize the presence of the person 730 located outside the first FOV 710 through the original image 110. Hence, by displaying the user interface indicating the identification information of the person 730, the HMD device 1000 may provide the user with information about whether there is the person 730, whether the person 730 is a new object that has never been detected from the original image 110, a moving direction and class of the person 730, etc.

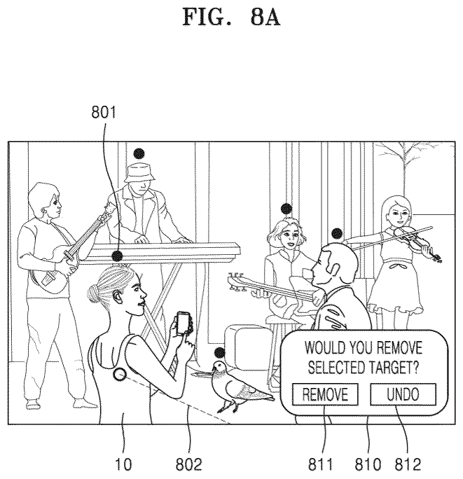

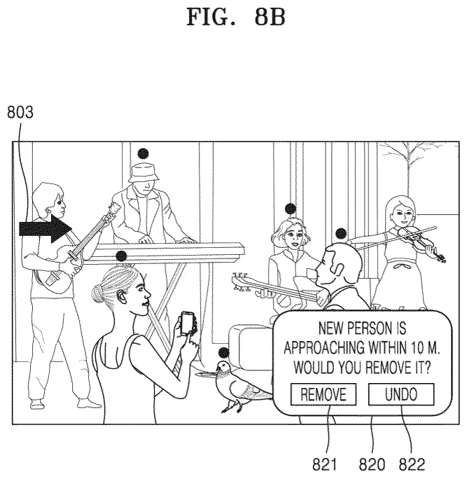

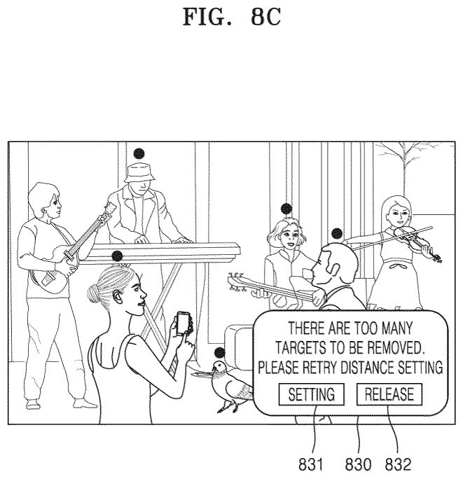

FIGS. 8A, 8B and 8C are diagrams for describing user interfaces, according to an embodiment of the disclosure.

Referring to FIG. 8A, the HMD device 1000 may display a user interface for selecting an inpainting target. For example, the HMD device 1000 may detect the first person 10 from the original image 110, and display a first indicator 801 on the detected first person 10 to indicate the first person 10. The HMD device 1000 may display a second indicator 802 indicating an object indicated by the user. The second indicator 802 may represent an imaginary line generated in a direction pointed by a user input or the user's hand in the 3D space corresponding to the original image 110, and an object that is met with the line. Moreover, when the object detected by the second indicator 802 is selected, the HMD device 1000 may display a first overlay interface 810 for determining the selected object as an inpainting target. The HMD device 1000 may obtain a user input to determine the first person 10 as a target object when the user selects ‘remove’ item 811 on the first overlay interface 810. The HMD device 1000 may obtain a user input to select a newly detected object when the user selects ‘undo’ item 812 on the first overlay interface 810.

Referring to FIG. 8B, the HMD device 1000 may display a user interface that indicates identification information of an object detected outside the first FOV 710. For example, the HMD 1000 may detect an object (e.g., the person 730 of FIG. 7) outside the first FOV 710 from the outer view image. When the detected object is one that is not detected from the original image 110, the HMD device 1000 may display a second overlay interface 820 indicating that a new object has been detected. The HMD device 1000 may obtain a user input to determine the object detected from outside the first FOV 710 as a target object when the user selects ‘remove’ item 821 on the second overlay interface 820. The HMD device 1000 may obtain a user input that does not determine the object detected from outside the first FOV 710 as a target object when the user selects ‘undo’ item 822.

Referring to FIG. 8C, the HMD device 1000 may display a user interface for determining a preset distance range. For example, the HMD device 1000 may identify whether the number of target objects is equal to or greater than a threshold. The threshold may be determined based on a hardware resource of the HMD device 1000. Specifically, the number of target objects may be limited in that when there are too many target objects, it may be difficult to perform proper inpainting due to limitations of hardware resources. The threshold may be determined based on a proportion of an area corresponding to the target object in the original image. The number of target objects may be limited in that the completion level of inpainting decreases when the proportion of the target object in the original image is too large.

In an embodiment of the disclosure, when the number of target objects is identified as being equal to or greater than the threshold, the HMD device 1000 may display a third overlay interface 830 to determine a preset distance range. The HMD device 1000 may obtain a user input to determine a preset distance range when the user selects a ‘setting’ item 831. The HMD device 1000 may obtain a user input to inactivate the inpainting mode when the user selects a ‘release’ item 832.

FIG. 9 is a flowchart for describing an operation of an HMD device for performing inpainting based on whether the inpainting is required, according to an embodiment of the disclosure. Operations S2400 and S250 of FIG. 9 correspond to operations S240 and S250 of FIG. 2, so the overlapping description will not be repeated.

In operation S910, the HMD device 1000 may identify whether inpainting for the target object is required based on motion information of the user who wears the HDM device.

In an embodiment of the disclosure, when identifying that inpainting for the target object is required in S910, the HMD device 1000 may obtain an inpainted image by inpainting the target object determined in the original image in S230.

Although operation S910 is shown in FIG. 9 as being performed after operations S240 and S250 in an embodiment of the disclosure, it is not limited thereto, and the operation S910 may be performed before operation S240 or between operations S250.

In an embodiment of the disclosure, the HMD device 1000 may obtain motion information of the user through a motion sensor. In an embodiment of the disclosure, the HMD device 1000 may identify whether the user is in motion based on the motion information of the user. In an embodiment of the disclosure, when the user is identified as being in motion, the HMD device 1000 may identify that inpainting for the target object is not required. In an embodiment of the disclosure, when the user is identified as not being in motion, the HMD device 1000 may identify that inpainting for the target object is required. Specifically, for safety of the user, the HMD device 1000 may prevent the user from bumping into the target object by not displaying the inpainted image while the user is in motion.

In an embodiment of the disclosure, the HMD device 1000 may identify whether the user is in motion based on the motion information of the user. Whether inpainting for the target object is required may be identified. In an embodiment of the disclosure, when the user is identified as being in motion based on the motion information of the user, the HMD device 1000 may determine that inpainting is not required. In an embodiment of the disclosure, when the user is identified as not being in motion based on the motion information of the user, the HMD device 1000 may determine that inpainting is required.

In an embodiment of the disclosure, the HMD device 1000 may obtain gaze direction information of the user's eyes through a gaze tracking sensor. In an embodiment of the disclosure, the HMD device 1000 may identify whether the user is focused on a virtual object based on the gaze direction information. For example, when it is identified that the user fixes his/her gaze on a displayed virtual object for a threshold time or more based on the gaze direction information of the user, it may be identified that the user is focused on the displayed virtual object. In an embodiment of the disclosure, when the user is identified as being focused on the virtual object, the HMD device 1000 may determine that inpainting is required. In an embodiment of the disclosure, when the user is identified as not being focused on the virtual object, the HMD device 1000 may identify that inpainting is not required. By performing inpainting only when the user is focused on the virtual object, the HMD device 1000 may provide an environment where the user is able to focus while preventing unnecessary hardware resource consumption.

FIG. 10 is a flowchart for describing an operation of an HMD device for performing noise canceling, according to an embodiment of the disclosure. Operations S240 and S250 of FIG. 10 correspond to operations S240 and S250 of FIG. 2, so the overlapping description will not be repeated.

In operation S1010, the HMD device 1000 may obtain a surrounding audio signal of a region where a target object is detected in the original image. In an embodiment of the disclosure, the HMD device 1000 may include a microphone for obtaining the surrounding audio signal at a time when the original image is captured. The HMD device 1000 may obtain a surrounding audio signal of a region where a target object is detected in the original image based on the signal obtained from the microphone.

In operation S1020, the HMD device 1000 may obtain an audio signal obtained by subtracting an audio signal corresponding to the target object from the obtained surrounding audio signal. In an embodiment of the disclosure, based on the obtained surrounding audio signal, the HMD device 1000 may classify and separate the obtained surrounding audio signal into each audio signal of each of the detected at least one object. For example, the HMD device 1000 may classify and separate the obtained surrounding audio signal into a sound corresponding to a car, a sound corresponding to a person, a sound corresponding to a bird, etc.

In an embodiment of the disclosure, the HMD device 1000 may identify an audio signal corresponding to a detected target object among the respective audio signals of the detected at least one object. For example, when the class of the target object is ‘bird’, a sound corresponding to the ‘bird’ may be identified among the classified audio signals.

In an embodiment of the disclosure, the HMD device 1000 may subtract the audio signal corresponding to the identified target object from the surrounding audio signal. In an embodiment of the disclosure, the HMD device 1000 may subtract the audio signal corresponding to the target object through a noise canceling algorithm. For example, the noise canceling algorithm may include filtering, masking, active noise cancellation (ANC) and digital signal processing (DSP), but is not limited thereto. In an embodiment of the disclosure, the HMD device 1000 may obtain an audio signal obtained by subtracting an audio signal corresponding to the identified target object from the surrounding audio signal.

In an embodiment of the disclosure, the HMD device 1000 may output an audio signal obtained by subtracting the audio signal corresponding to the obtained target object. For example, the HMD device 1000 may include a speaker for outputting the audio signal, and may output an audio signal obtained by subtracting the audio signal corresponding to the obtained target object through the speaker at a time when the inpainted image is displayed.

As such, according to an embodiment of the disclosure, the HMD device 1000 may help the user focus on the inpainted image where the target object is removed, by removing the audio signal of the target object as well.

Although operation S250 is shown in FIG. 10 as being performed after operations S1010 and S1020, it is not limited thereto, and operation S250 may be performed before operations S1010 and S1020, or operation S250 may not be performed but only operations S1010 and 1020 may be performed.

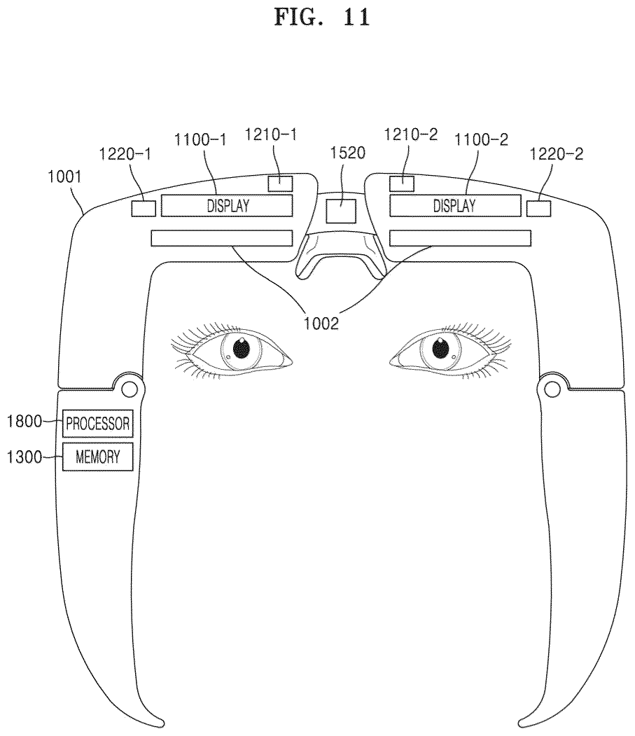

FIG. 11 is a perspective view of an HMD device, according to an embodiment of the disclosure.

Referring to FIG. 11, the HMD device 1000 may include a frame 1001, an optical system 1002, a display 1100-1 or 1100-2, a stereo camera 1210-1 or 1210-2, a sub-camera 1220-1 or 1220-2, a memory 1300, a distance detection sensor 1520 and a processor 1800. It is not, however, limited thereto, and some of the components may be omitted therefrom or another component may be added thereto.

In an embodiment of the disclosure, the frame 1001 may include the other components of the HMD device 1000, and may be arranged to allow the user to mount the HMD device 1000 thereon, including temples, a nose bridge, etc., without being limited thereto. In an embodiment of the disclosure, left-eye optical components and right-eye optical components may be placed or attached to the left and right sides of the frame 1001, or the left-eye optical components and the right-eye optical components may be integrally formed and mounted on the frame 1001. In another example, some of the optical components may be placed or attached to only one of the left and right sides of the frame 1001.

In an embodiment of the disclosure, the optical system 1002 may be a component to transmit light of an image to the user's eyes. In an embodiment of the disclosure, the optical system 1002 may include at least one lens having a refractive power (strength) to focus or change the path of light of an image output from the display 1100-1 or 1100-2. In an embodiment of the disclosure, the light of the image output from the display 1100-1 or 1100-2 may pass through the optical system 1002 and may enter the user's eyes.

The display 1100-1 or 1100-2 is a component to display an image. The light of the image output from the display 1100-1 or 1100-2 may enter the eyes of the user who wears the VR HMD device 1000. In an embodiment of the disclosure, the display 1100-1 or 1100-2 may be configured with a physical device including at least one of a liquid crystal display, a thin film transistor-liquid crystal display, an organic light-emitting diode, a flexible display, a 3D display, or an electrophoretic display. In an embodiment of the disclosure, the displays 1100-1 and 1100-2 may include the left-eye display 1100-1 and the right-eye display 1100-2, and the left-eye display 1100-1 may display the left-eye image of a stereo image and the right-eye display 1100-2 may display the right-eye image of the stereo image. It is not, however, limited thereto, and the HMD device 1000 may include a single display where the left-eye image may be displayed in a portion of the single display and the right-eye image may be displayed in another portion.

The stereo camera 1210-1 or 1210-2 is configured to obtain an image of an object and background in a real environment by capturing an image of the real environment. In an embodiment of the disclosure, the stereo camera 1210-1 or 1210-2 may include a lens module, an image sensor and an image processing module, and may obtain an image or video through an image sensor (e.g., CMOS or CCD). In an embodiment of the disclosure, the stereo cameras 1210-1 and 1210-2 may include the left-eye camera 1210-1 and the right-eye camera 1210-2. In an embodiment of the disclosure, the stereo cameras 1210-1 and 1210-2 may obtain stereo images based on the images obtained from the left-eye camera 1210-1 and the right-eye camera 1210-2. In an embodiment of the disclosure, the stereo camera 1210-1 or 1210-2 may obtain an original image by capturing an image of the real environment with the first FOV 710. It is not, however, limited thereto, and the HMD device 1000 may include a single camera or three or more cameras instead of the stereo cameras 1210-1 and 1210-2, and may obtain an original image from the single camera or the multiple cameras.

The sub-camera 1220-1 or 1220-2 is configured to obtain an image of a surrounding environment and a hand gesture of the user by capturing an image of the real environment. In an embodiment of the disclosure, the sub-camera 1220-1 or 1220-2 may include a lens module, an image sensor and an image processing module, and may obtain an image or video through an image sensor (e.g., CMOS or CCD). In an embodiment of the disclosure, the sub-camera 1220-1 or 1220-2 may obtain an outer view image by capturing an image of the real environment with the second FOV 720. It is not, however, limited thereto, and the HMD device 1000 may include a single camera or three or more cameras instead of the sub-cameras 1220-1 and 1220-2, and may obtain an outer view image from the single camera or the multiple cameras.

The distance detection sensor 1520 is configured to obtain data about a distance between an object in the real environment and the sensor. In an embodiment of the disclosure, the distance detection sensor 1520 may include an ultrasound sensor for measuring data about the distance based on sound reflection time, a laser sensor for measuring data about the distance based on a light reflection time or a phase change, etc. In an embodiment of the disclosure, the HMD device 1000 may generate a depth map of the original image based on the data obtained from the distance detection sensor 1520, or generate a 3D space including at least one object detected from the original image and the outer view image.

In an embodiment of the disclosure, the HMD device 1000 may include electronic components such as the memory 1300 and the processor 1800, and the electronic components may be mounted on a printed circuit board (PCB), a flexible PCB (FPCB), etc., which may be located at one place or distributed at multiple places on the frame 1001. In an embodiment of the disclosure, the electronic components included in the HMD device 1000 may further include a communication interface, an input interface, an output interface, etc., and a detailed description of operation of the electronic components of the HMD device 1000 will be described later in connection with FIG. 13.

FIG. 12 is a detailed block diagram of an HMD device, according to an embodiment of the disclosure. Referring to FIG. 12, the HMD device 1000 may include the display 1100, the stereo camera 1210, the sub-camera 1220, the memory 1300, a communication interface 1400, a motion detection sensor 1510, a distance detection sensor 1520, an input interface 1600, an output interface 1700 and the processor 1800. The display 1100, the stereo camera 1210, the sub-camera 1220, the memory 1300, the communication interface 1400, the motion sensor 1510, the distance detection sensor 1520, a gaze tracking sensor 1530, the input interface 1600, the output interface 1700 and the processor 1800 may be electrically and/or physically connected to one another.

The components as shown in FIG. 12 are merely according to an embodiment of the disclosure, but the components included in the HMD device 1000 are not limited thereto. The HMD device 1000 according to an embodiment of the disclosure may not include some of the components as shown in FIG. 12 or may further include components not shown in FIG. 12. Descriptions of overlapping components between FIG. 11 and FIG. 12 will not be repeated.

Instructions or program codes for performing functions or operations of the HMD device 1000 may be stored in the memory 1300. In an embodiment of the disclosure, the at least one instruction, algorithms, data structures, program codes and application programs stored in the memory 1300 may be implemented in e.g., a programming or scripting language such as C, C++, Java, assembler, etc.

In an embodiment of the disclosure, the memory 1300 may include at least one of a flash memory type, a hard disk type, a multimedia card micro type, a card type memory (e.g., secure digital (SD) or extreme digital (XD) memory), a random access memory (RAM), a static RAM (SRAM), a read-only memory (ROM), an electrically erasable programmable ROM (EEPROM), a programmable ROM (PROM), a mask ROM, a flash ROM, a hard disc drive (HDD) or a solid state drive (SSD).

In an embodiment of the disclosure, the memory 1300 may include prestored panorama images. The prestored panorama images may be obtained from the stereo camera 1210 and stored in the memory 1300, or received from an external electronic device through the communication interface 1400 and stored in the memory 1300. In an embodiment of the disclosure, the memory 1300 may include the original image, the outer view image and the depth map of the original image. In an embodiment of the disclosure, the memory 1300 may include detection results and tracing results of objects included in the original image and the outer view image. In an embodiment of the disclosure, the memory 1300 may include an object detection model, a segmentation model, an object tracing model, and an inpainting model. It is not, however, limited thereto, and the memory 1300 may further include various data required to perform operations and functions of the HMD device 1000 as described in the disclosure.

The communication interface 1400 is a component for the HMD device 1000 to communicate with an external electronic device. In an embodiment of the disclosure, the communication interface 1400 may perform data communication between the HMD device 1000 and the external electronic device by using at least one of data communication schemes including, for example, a wireless local area network (WLAN), Wi-Fi, Bluetooth, ZigBee, WFD, infrared data association (IrDA), bluetooth low energy (BLE), near field communication (NFC), wireless broadband Internet (Wibro), world interoperability for microwave access (WiMAX), shared wireless access protocol (SWAP), wireless gigabit alliance (WiGig) and radio frequency (RF) communication.

In an embodiment of the disclosure, the communication interface 1400 may transmit or receive at least one of the original image, the outer view image, or the inpainted image to or from the external electronic device. It is not, however, limited thereto, and various data required to perform operations and functions of the HMD device 1000 as described in the disclosure may be transmitted or received to or from the external electronic device through the communication interface 1400.

The motion sensor 1510 is a component for measuring the location, speed, direction, position, etc., of the HMD device 1000. In an embodiment of the disclosure, the motion sensor may include an inertial measurement unit (IMU) sensor. The IMU sensor may obtain 6 degree of freedom (DoF) measurements including position coordinates (x-axis, y-axis and z-axis coordinates) and thee-axis angular velocity values (roll, yaw and pitch) of the user who wears the HMD device 1000. It is not, however, limited thereto, and the motion sensor 1510 may include various sensors for obtaining data required to identify whether the user who wears the HMD device 1000 is in motion.

The gaze tracking sensor 1530 is a component for obtaining gaze direction information of the user's eyes. The gaze tracking sensor 1530 may detect a gaze direction of the user by detecting a human pupil image or detecting a direction or amount of illumination such as near-infrared rays reflected from the cornea. The gaze tracking sensor 1530 may include a left-eye gaze tracking sensor and a right-eye gaze tracking sensor for detecting left-eye and right-eye gaze directions of the user, respectively. The detecting of the user's gaze direction may refer to obtaining the user's gaze direction information.

The input interface 1600 is a component for receiving various user inputs. In an embodiment of the disclosure, the input interface 1600 may include a touch panel, a physical button, a microphone, etc. In an embodiment of the disclosure, information input through the input interface 1600 may be provided to the processor 1800. In an embodiment of the disclosure, a user input that determines a preset distance range may be obtained through the input interface 1600. In an embodiment of the disclosure, a user input that selects a preset class may be obtained through the input interface 1600. In an embodiment of the disclosure, a user input that selects an inpainting target may be obtained through the input interface 1600. In an embodiment of the disclosure, a user input that activates or inactivates an inpainting mode may be obtained through the input interface 1600. In an embodiment of the disclosure, the input interface 1600 may obtain a surrounding audio signal at a time when the original image is captured. It is not, however, limited thereto, and various data required to perform operations and functions of the HMD device 1000 as described in the disclosure may be input through the input interface 1600.

The output interface 1700 is a component for the HMD device 1000 to provide various information to the user. In an embodiment of the disclosure, the output interface 1700 may include a speaker. In an embodiment of the disclosure, the output interface 1700 may output voices corresponding to text displayed through the user interface or output voices about whether the inpainting mode is activated based on a signal received from the processor 1800. It is not, however, limited thereto, and various voices required to perform operations and functions of the HMD device 1000 as described in the disclosure may be output through the output interface 1700.

The processor 1800 may control general operations of the HMD device 1000. In an embodiment of the disclosure, the processor 1800 may include a plurality of processors. In an embodiment of the disclosure, the at least one processor 1800 may execute one or more instructions of a program stored in the memory 1300 to perform operations and functions of the HMD device 1000 described in the disclosure.

The processor 1800 may include at least one of e.g., a central processing unit (CPU), a microprocessor, a graphic processing unit (GPU), an application specific integrated circuit (ASIC), a digital signal processor (DSP), a digital signal processing device (DSPD), a programmable logic device (PLD), a field programmable gate array (FPGA), an application processor (AP), a neural processing unit (NPU) or an AI specific processor designed in a hardware structure specialized in processing of an AI model, without being limited thereto.

In a case that the method according to an embodiment of the disclosure includes a plurality of operations, the plurality of operations may be performed by one or more of the processors. For example, when a first operation, a second operation and a third operation are to be performed in a method according to an embodiment of the disclosure, all the first operation, the second operation and the third operation may be performed by a first processor, or the first operation and the second operation may be performed by the first processor and the third operation may be performed by a second processor. However, an embodiment of the disclosure is not limited thereto.

In the disclosure, the one or more processors may be implemented as a single core processor or a multi-core processor. In a case that the method according to an embodiment of the disclosure includes a plurality of operations, the plurality of operations may be performed by a single core or performed by multiple cores included in the one or more processors.

In an embodiment of the disclosure, the at least one processor 1800 may be configured to execute the at least one instruction to obtain an original image by capturing a real environment through the stereo camera 1210. In an embodiment of the disclosure, the at least one processor 1800 may be configured to execute the at least one instruction to detect at least one object included in the original image. In an embodiment of the disclosure, the at least one processor 1800 may be configured to execute the at least one instruction to obtain depth information of the at least one object using the original image. In an embodiment of the disclosure, the at least one processor 1800 may be configured to execute the at least one instruction to identify a target object from among the detected at least one object based on depth information. In an embodiment of the disclosure, the at least one processor 1800 may be configured to execute the at least one instruction to inpaint a region corresponding to the target object in the original image. In an embodiment of the disclosure, the at least one processor 1800 may be configured to execute the at least one instruction to display the inpainted image through the display 1100.

In an embodiment of the disclosure, the at least one processor 1800 may be configured to execute the at least one instruction to identify at least one object located in a preset distance range from the HMD device 1000 among the detected at least one object based on the depth information. In an embodiment of the disclosure, the at least one processor 1800 may be configured to execute the at least one instruction to identify a target object among the identified at least one object.

In an embodiment of the disclosure, the at least one processor 1800 may be configured to execute the at least one instruction to display a virtual object through the display 1100. In an embodiment of the disclosure, the at least one processor 1800 may be configured to execute the at least one instruction to identify a preset distance range based on the displayed virtual object.

In an embodiment of the disclosure, the at least one processor 1800 may be configured to execute the at least one instruction to identify an object classified into a preset class as a target object among the identified at least one object.

In an embodiment of the disclosure, the at least one processor 1800 may be configured to execute the at least one instruction to obtain a user input to select at least one of the identified at least one object as an inpainting target. In an embodiment of the disclosure, the at least one processor 1800 may be configured to execute the at least one instruction to identify the object selected as the inpainting target among the identified at least one object as a target object.

In an embodiment of the disclosure, the at least one processor may be configured to execute the at least one instruction to obtain a mask map representing an area corresponding to the target object determined in the original image. In an embodiment of the disclosure, the at least one processor 1800 may be configured to execute the at least one instruction to obtain an inpainted image by applying the original image and the mask map to a learning model for inpainting the target object.

In an embodiment of the disclosure, the at least one processor 1800 may be configured to execute the at least one instruction to obtain an outer view image representing the second FOV wider than the first FOV of the original image through the sub-camera. In an embodiment of the disclosure, based on the original image and the outer view image, the at least one processor 1800 may be configured to execute the at least one instruction to trace at least one object moving in and out of the first FOV.

In an embodiment of the disclosure, the at least one processor 1800 may be configured to execute the at least one instruction to output a user interface indicating identification information of at least one object located outside the first FOV through a display.

In an embodiment of the disclosure, the at least one processor 1800 may be configured to execute the at least one instruction to identify whether inpainting for the identified target object is required based on obtained motion information. In an embodiment of the disclosure, the at least one processor 1800 may be configured to execute the at least one instruction to inpaint the region corresponding to the identified target object based on identifying that the inpainting is required.

FIG. 13 is a detailed block diagram of a server, according to an embodiment of the disclosure.

Referring to FIG. 13, a server 2000 may include a memory 2100, a communication interface 2200 and a processor 2300. They are electrically and/or physically connected to one another.

The components as shown in FIG. 13 are merely according to an embodiment of the disclosure, but the components included in the server 2000 are not limited thereto. The server 2000 according to an embodiment of the disclosure may not include some of the components shown in FIG. 13 or may further include components not shown in FIG. 13.

Instructions or program codes for performing functions or operations of the server 2000 may be stored in the memory 2100. In an embodiment of the disclosure, the at least one instruction, algorithms, data structures, program codes and application programs stored in the memory 2100 may be implemented in e.g., a programming or scripting language such as C, C++, Java, assembler, etc.

In an embodiment of the disclosure, the memory 2100 may include at least one of a flash memory type, a hard disk type, a multimedia card micro type, a card type memory (e.g., secure digital (SD) or extreme digital (XD) memory), a random access memory (RAM), a static RAM (SRAM), a read-only memory (ROM), an electrically erasable programmable ROM (EEPROM), a programmable ROM (PROM), a mask ROM, a flash ROM, a hard disc drive (HDD) or a solid state drive (SSD).

In an embodiment of the disclosure, the memory 2100 may include prestored panorama images. The prestored panorama images may be obtained from the HMD device 1000 through the communication interface 2200 and stored in the memory 2100, or received from an external electronic device through the communication interface 2200 and stored in the memory 2100. In an embodiment of the disclosure, the memory 2100 may include the original image, the outer view image and the depth map of the original image. In an embodiment of the disclosure, the memory 2100 may include detection results and tracing results of objects included in the original image and the outer view image. In an embodiment of the disclosure, the memory 2100 may include an object detection model, a segmentation model, an object tracing model, and an inpainting model. It is not, however, limited thereto, and the memory 2100 may further include various data required to perform operations and functions of the HMD device 1000 as described in the disclosure.

The communication interface 2200 is a component for the server 2000 to communicate with the HMD device 1000 or an external electronic device. In an embodiment of the disclosure, the communication interface 2200 may perform data communication with the HMD device 1000 or the external electronic device by using at least one of data communication schemes including a wireless local area network (WLAN), Wi-Fi, Bluetooth, ZigBee, WFD, infrared data association (IrDA), bluetooth low energy (BLE), near field communication (NFC), wireless broadband Internet (Wibro), world interoperability for microwave access (WiMAX), shared wireless access protocol (SWAP), wireless gigabit alliance (WiGig) and radio frequency (RF) communication.

In an embodiment of the disclosure, the communication interface 2200 may transmit or receive at least one of the original image, the outer view image, or the inpainted image to or from the HMD device 1000 or the external electronic device. It is not, however, limited thereto, and various data required to perform operations and functions of the HMD device 1000 as described in the disclosure may be transmitted or received to or from the HMD device 1000 or the external electronic device through the communication interface 1400.

The processor 2300 may control general operations of the server 2000. In an embodiment of the disclosure, the processor 2300 may include a plurality of processors. In an embodiment of the disclosure, the at least one processor 2300 may execute one or more instructions of a program stored in the memory 2100 to perform operations and functions of the HMD device 1000 as described in the disclosure. In an embodiment of the disclosure, the at least one processor 2300 may be configured to execute the at least one instruction to identify at least one object located in a preset distance range from the HMD device 1000 among the detected at least one object based on the depth information. In an embodiment of the disclosure, the at least one processor 2300 may be configured to determine a target object among the identified at least one object. Operations and functions of the processor 2300 correspond to the operations and functions of the processor 1800 of the HMD device 1000 as described in FIG. 2, so the overlapping description will not be repeated.

In the meantime, embodiments of the disclosure may be implemented in the form of a recording medium that includes computer-executable instructions such as the program modules executed by the computer. Computer-readable mediums may be an arbitrarily available medium that may be accessed by the computer, including volatile, non-volatile, removable, and non-removable mediums. The computer-readable medium may also include a computer storage medium and a communication medium. The computer storage medium includes all the volatile, non-volatile, removable, and non-removable mediums implemented by an arbitrary method or technology for storage of information, such as computer-readable instructions, data structures, program modules, or other data. The communication medium may include other data of modulated data signals such as computer-readable instructions, data structures, or program modules.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

Several embodiments have been described, but a person of ordinary skill in the art will understand and appreciate that various modifications can be made without departing the scope of the disclosure. Thus, it will be apparent to those of ordinary skill in the art that the disclosure is not limited to the embodiments described, but can encompass not only the appended claims but the equivalents. For example, an element described in the singular form may be implemented as being distributed, and elements described in a distributed form may be implemented as being combined.

The scope of the disclosure is defined by the appended claims, and it will be understood by those of ordinary skill in the art that various changes in form and details may be made without departing from the spirit and scope of the disclosure as defined by the appended claims and their equivalents.

What is claimed is:

1. An operation method of a head-mounted display (HMD) device, the operation method comprising:
obtaining an original image by capturing a real environment;
detecting at least one object included in the original image;
obtaining depth information of the detected at least one object using the original image;
identifying a target object among the detected at least one object based on the depth information;
inpainting a region corresponding to the identified target object in the original image; and
displaying the inpainted image.

2. The operation method of claim 1, further comprising obtaining the original image based on at least one of a stereo image obtained through a stereo camera included in the HMD device or a prestored panorama image.

3. The operation method of claim 1, wherein the identifying the target object comprises:
identifying at least one object located within a preset distance range from the HMD device among the detected at least one object based on the depth information; and
identifying the target object among the identified at least one object.

4. The operation method of claim 3, further comprising:
displaying a virtual object; and
identifying the preset distance range based on the displayed virtual object.

5. The operation method of claim 3, wherein the identifying the target object comprises identifying an object classified into a preset class as the target object among the identified at least one object.

6. The operation method of claim 3, further comprising obtaining a user input to select at least one of the detected at least one object as an inpainting target,
wherein the identifying the target object comprises identifying an object selected as the inpainting target as the target object among the identified at least one close object.

7. The operation method of claim 1, wherein the obtaining the inpainted image comprises:
obtaining a mask map representing an area corresponding to the identified target object in the original image; and
obtaining the inpainted image by applying the original image and the mask map to an inpainting model for inpainting the target object.

8. The operation method of claim 1, further comprising:
obtaining an outer view image representing a second field of view (FOV) wider than a first FOV of the original image; and
tracing the detected at least one object moving in and out of the first FOV based on the original image and the outer view image.

9. The operation method of claim 8, further comprising displaying a user interface indicating identification information of the detected at least one object located outside the first FOV.

10. The operation method of claim 1, further comprising identifying whether inpainting for the identified target object is required based on motion information of a user wearing the HMD device,
wherein the obtaining the inpainted image comprises, based on identifying that the inpainting is required, performing inpainting for the identified target object.

11. A head-mounted display (HMD) device comprising:
a display;
a stereo camera;
a memory storing at least one instruction; and
at least one processor configured to execute the at least one instruction stored in the memory,
wherein the at least one instruction, when executed by the at least one processor, causes the HMD device to:
obtain an original image by capturing a real environment through the stereo camera;
detect at least one object include in the original image;
obtain depth information of the at least one detected object using the original image;
identify a target object from among the detected at least one object based on depth information;
inpaint a region corresponding to the identified target object in the original image; and
display the inpainted image through the display.

12. The HMD device of claim 11, wherein the at least one instruction, when executed by the at least one processor, causes the HMD device to:
identify at least one object located within a preset distance range from the HMD device among the detected at least one object based on the depth information; and
identify the target object among the identified at least one object.

13. The HMD device of claim 12, wherein the at least one instruction, when executed by the at least one processor, causes the HMD device to:
display a virtual object through the display; and
identify the preset distance range based on the displayed virtual object.

14. The HMD device of claim 13, wherein the at least one instruction, when executed by the at least one processor, causes the HMD device to identify an object classified into a preset class as the target object among the identified at least one object.

15. The HMD device of claim 13, wherein the at least one instruction, when executed by the at least one processor, causes the HMD device to:
obtain a user input to select at least one of the detected at least one object as an inpainting target; and
identify an object selected as the inpainting target as the target object among the identified at least one close object.

16. The HMD device of claim 11, wherein the at least one instruction, when executed by the at least one processor, causes the HMD device to:
obtain a mask map representing an area corresponding to the identified target object in the original image; and
obtain the inpainted image by applying the original image and the mask map to a learning model for inpainting the target object.

17. The HMD device of claim 11, further comprising a sub-camera,
wherein the at least one instruction, when executed by the at least one processor, causes the HMD device to:
through the sub-camera, obtain an outer view image representing a second field of view (FOV) wider than a first FOV of the original image; and
trace the at least one object moving in and out of the first FOV based on the original image and the outer view image.

18. The HMD device of claim 17, wherein the at least one instruction, when executed by the at least one processor, causes the HMD device to output, through the display, a user interface indicating identification information of the at least one object located outside the first FOV.

19. The HMD device of claim 11, further comprising a motion sensor configured to obtain motion information of a user,
wherein the at least one instruction, when executed by the at least one processor, causes the HMD device to:
identify whether inpainting for the identified target object is required based on the obtained motion information of the user; and
based on identifying that the inpainting is required, perform inpainting for the identified target object.

20. A non-transitory computer-readable recording medium having recorded thereon a program to cause a computer to execute a method comprising:
obtaining an original image by capturing a real environment;
detecting at least one object included in the original image;
obtaining depth information of the detected at least one object using the original image;
identifying a target object among the detected at least one object based on the depth information;
inpainting a region corresponding to the identified target object in the original image; and
displaying the inpainted image.
